(19) United States
(12) Patent Application Publication
(10) Pub. No.: US 2008/0179114 A1
(43) Pub. Date: Jul. 31, 2008

(54) VEHICULAR WIND POWER GENERATION DEVICE

(75) Inventor: Tai-Liang CHEN, Kaohsiung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignees: Yang-Ching YEH; Tai-Liang CHEN; Cheng-Yu HSIEH; Shun-Chang HSU

(21) Appl. No.: 12/022,744

(22) Filed: Jan. 30, 2008

(30) Foreign Application Priority Data
Jan. 31, 2007 (TW) 096122958

(51) Int. Cl. B60K 16/00; B60L 8/00; F03D 9/02; H02J 7/14

(52) U.S. Cl. 180/2.2; 320/101; 290/55

(57) ABSTRACT

A vehicular wind power generation device is provided for a vehicle including a bumper facing and guiding a windward current. The device includes a wind guiding hood with a wind guiding inlet and outlet communicating therewith, a directing-rotating element disposed at the wind guiding outlet, a power generator, and a power storage unit. The windward area of the wind guiding inlet is greater than that of the wind guiding outlet. The wind guiding inlet is connected to the bumper so as to receive the windward current blowing out of the wind guiding outlet, thus allowing the directing-rotating element to receive the windward current. The power generator is connected to the directing-rotating element and the power storage unit. The directing-rotating element is rotated by the windward current blowing toward the directing-rotating element while the vehicle is in motion. Eventually, the power generator generates power for providing rechargeable power for the vehicle.

This application claims the benefit of Taiwan Patent Application No. 096122958, filed on Jan. 31, 2007, which is hereby incorporated by reference for all purposes as if fully set forth herein.

### BACKGROUND OF THE INVENTION

1. Field of the Invention

The present invention relates to a vehicular wind power generation device, and more particularly, to an improved vehicular wind power generation device, for generating vehicular rechargeable power, using the wind resulting from a vehicle in motion.

2. Description of the Prior Art

In general, power is generated by combustion of hydrocarbons to drive the engine of a vehicle. However, resources of crude oil have never been scarcer than they are now, and their prices are increasingly high. The greenhouse effect, which arises from decades of consumption of petroleum, and other types of pollution are becoming more serious. Conventional hydrocarbon vehicles are going to use up the earth's resources sooner or later. Last but not least, vehicle hydrocarbon emission aggravates pollution.

To solve the aforesaid problems and cope with gasoline-induced pollution, the industrial sector launched electrically driven vehicles on the market. As an electrical means of transportation exemplified by vehicles, electrically driven vehicles nowadays are of three types, namely electric vehicles, solar vehicles, and vehicles powered by fuel cells.

An electric vehicle is equipped with a vehicular cell for storing electric power. Generally speaking, power storage capacity of vehicular cells, however, is quite limited if not little, compared to the petroleum fuel for driving an internal combustion-based means of transportation. As a result, electric vehicles have their drawbacks, such as inevitably short drives, frequent charging, slow charging, time-consuming charging, lack of ease of use, and lack of user-friendliness. Accordingly, electric vehicles are not in wide use.

A solar vehicle is equipped with a solar power generating device for generating electric power, and storing the electric power in a vehicular cell in order to drive the motor. Solar vehicles are not in wide use because of unreliable sources of sunlight and bulky solar panels.

Vehicles powered by fuel cells are also not in wide use, because fuel cells are bulky and expensive.

Accordingly, what is in urgent need of a solution is that, the electric vehicles put on the market by the industrial sector are faced with plenty unsolved user-unfriendly problems.

### SUMMARY OF THE INVENTION

In view of the existing drawbacks of the prior art, the present invention provides a vehicular wind power generation device with a view to overcome the existing drawbacks of electrically driven vehicles, such as limited power storage capacity, frequent charging, and lack of ease of use, and to solve the pollution caused by hydrocarbon vehicles. To achieve the aforesaid objectives, the present invention provides a vehicular wind power generation device for supplying rechargeable power to a vehicle. The vehicle comprises a bumper facing and guiding a windward current. The vehicular wind power generation device of the present invention comprises a wind guiding hood with at least a wind guiding inlet and at least a wind guiding outlet communicating therewith, a directing-rotating element disposed at the wind guiding outlet, a power generator, and a power storage unit. The windward area of the wind guiding inlet is greater than that of the wind guiding outlet. The wind guiding inlet is connected to the bumper so as to receive a windward current guided by the bumper. The windward current is blown out of the wind guiding outlet and received by the directing-rotating element. The power generator is connected to the directing-rotating element and the power storage unit for storing power while the power generator is operating. The directing-rotating element is rotated by the windward current blowing toward the directing-rotating element while the vehicle is in motion, thus enabling the power generator to operate and generate power, and eventually the power generated is stored in the power storage unit.

The present invention relates to a vehicular wind power generation device and features advantages over the prior art and marked improvements as follows:

With a vehicular wind power generation device of the present invention, a power generator driven by a directing-rotating element operates and generates power continuously while a vehicle is in motion, thus providing rechargeable power for the vehicle continuously. The known inconvenience caused by insufficient power storage and therefore frequent charging is eliminated by the present invention, not to mention that the present invention is efficient in tackling air pollution and other forms of pollution.

The objectives, structural features, and functions of the present invention are described in detail below with embodiment in reference to the accompanying drawings.

### BRIEF DESCRIPTION OF THE DRAWINGS

FIG. 1 is a schematic view showing a vehicular wind power generation device according to the present invention;

FIG. 2 is a schematic view showing the vehicular wind power generation device installed in a vehicle according to the present invention; and

FIG. 3 is a schematic view showing the vehicular wind power generation device operated in vehicle according to the present invention.

### DETAILED DESCRIPTION OF THE PREFERRED EMBODIMENT

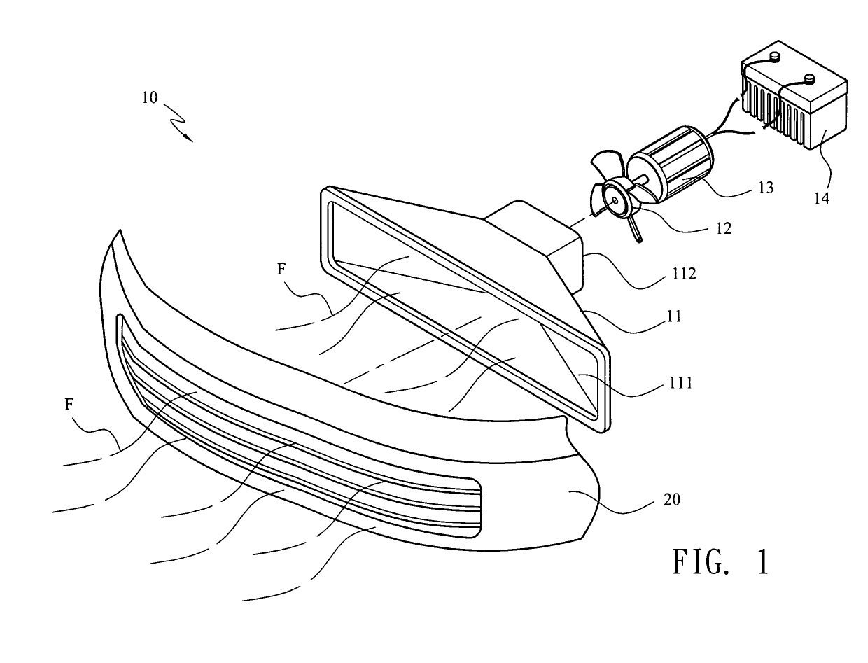

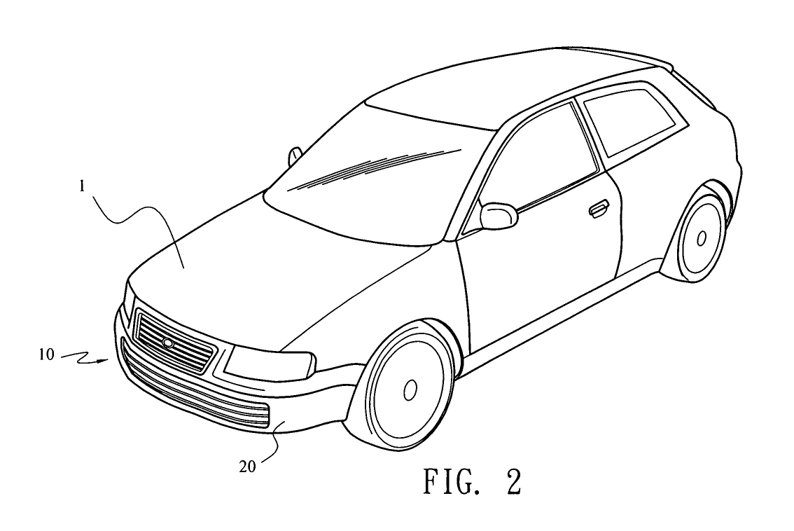

Referring to FIG. 1 and FIG. 2, the present invention relates to a vehicular wind power generation device. The vehicular wind power generation device 10 provides rechargeable power for a vehicle 1, wherein the vehicle 1 comprises a bumper 20 facing and guiding a windward current F. The vehicular wind power generation device 10 also comprises a wind guiding hood 11, a directing-rotating element 12, a power generator 13, and a power storage unit 14.

The wind guiding hood 11 comprises at least a wind guiding inlet 111 and at least a wind guiding outlet 112 communicating therewith. The windward area of the wind guiding inlet 111 is greater than that of the wind guiding outlet 112. The wind guiding inlet 111 of the wind guiding hood 11 is connected to the bumper 20 so as to receive the windward current F guided by the bumper 20, and the windward current F is blown out of the wind guiding outlet 112. The directing-rotating element 12 is disposed at the wind guiding outlet 112 of the wind guiding hood 11 so as to receive the windward current F blown out of the wind guiding outlet 112. The directing-rotating element 12 is, but not limited to, a fan. The power generator 13 is connected to the directing-rotating element 12. In addition, the power storage unit 14 is connected to the power generator 13 to provide power storage while the power generator 13 is operating. In the preferred embodiment, the power storage unit 14 is, but not limited to, a battery, or a combination of a battery charger and a battery stack.

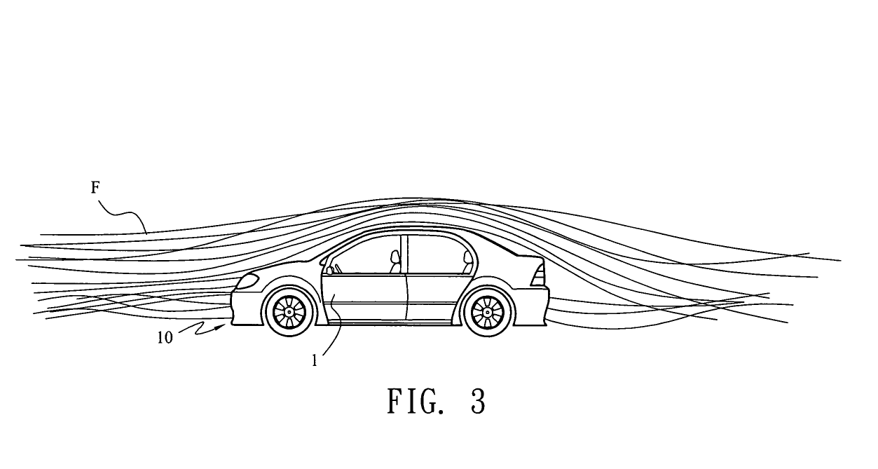

Referring to FIG. 1, FIG. 2, and FIG. 3, upon completion of assembly of the vehicular wind power generation device 10, the speed of the windward current F increases, not only because the directing-rotating element 12 is rotated by the windward current F resulting from the vehicle 1 in motion and blowing toward the directing-rotating element 12 wherein the windward current F is guided by the bumper 20 facing and guiding the windward current F, but also because the windward area of the wind guiding inlet 111 is greater than that of the wind guiding outlet 112. To be specific, the equation which describes the relationship between speed and area in fluid mechanics, that is, M1×A1=M2×A2 (where M denotes speed, and A denotes area), has the following meaning: given a constant flow of the windward current F, A1>A2 means M2>M1, or, in other words, if the windward area of the wind guiding inlet 111 is greater than that of the wind guiding outlet 112, the windward current F will be rapidly vented from the wind guiding outlet 112, and the directing-rotating element 12 will rotate rapidly and continuously. The faster the directing-rotating element 12 rotates, the faster the power generated by the power generator is stored in the power storage unit, thus providing rechargeable power for the vehicle 1 continuously. As a result, the vehicle 1 generates rechargeable power while moving.

The aforesaid embodiment merely serves as the preferred embodiment of the present invention. The aforesaid embodiment should not be construed as to limit the scope of the present invention in any way. Hence, many other changes can actually be made in the present invention. It will be apparent to those skilled in the art that all equivalent modifications or changes made to the present invention, without departing from the spirit and the technical concepts disclosed by the present invention, should fall within the scope of the appended claims.

What is claimed is:

1. A vehicular wind power generation device providing rechargeable power for a vehicle, said vehicle comprising a bumper facing and guiding a windward current, said vehicular wind power generation device comprising:
a wind guiding hood comprising at least a wind guiding inlet and at least a wind guiding outlet communicating therewith, a windward area of said wind guiding inlet being greater than a windward area of said wind guiding outlet, said wind guiding inlet of said wind guiding hood being connected to said bumper so as to receive said windward current guided by said bumper, said windward current being blown out of said wind guiding outlet;
a directing-rotating element disposed at said wind guiding outlet of said wind guiding hood to receive said windward current blown out of said wind guiding outlet;
a power generator connected to said directing-rotating element; and
a power storage unit connected to said power generator to provide power storage while said power generator is operating;
wherein said windward current is blown toward said directing-rotating element to rotate said directing-rotating element and enables said power generator to operate and generate power, and store power in said power storage unit.

2. The vehicular wind power generation device according to claim 1, wherein said directing-rotating element is a fan.

3. The vehicular wind power generation device according to claim 1, wherein said power storage unit is a battery.

4. The vehicular wind power generation device according to claim 1, wherein said power storage unit is a combination of a battery charger and a battery stack.
